(19) United States
(12) Patent Application Publication
(10) Pub. No.: US 2010/0104929 A1
(43) Pub. Date: Apr. 29, 2010

(54) BATTERY MANAGEMENT SYSTEM FOR AN ELECTRICAL DEVICE WORKING IN ACCORDANCE WITH GALVANIC PRINCIPLES, FOR EXAMPLE A LITHIUM-ION CELL

(75) Inventors: Tim Schäfer, Niedersachswerfen (DE); Andreas Gutsch, Lüdinghausen (DE)

Correspondence Address: WEINGARTEN, SCHURGIN, GAGNEBIN & LEBOVICI LLP, TEN POST OFFICE SQUARE, BOSTON, MA, 02109, US

(73) Assignee: LI-TEC BATTERY GMBH, Kamenz (DE)

(21) Appl. No.: 12/603,129

(22) Filed: Oct. 21, 2009

(30) Foreign Application Priority Data
Oct. 23, 2008 (DE) 10 2008 052 986.9

(51) Int. Cl. H01M 10/48

(52) U.S. Cl. 429/90

(57) ABSTRACT

The invention relates to a battery management system (10) for monitoring and controlling of at least one device (14, 14′), which works according to galvanic principles, in particular a lithium-ion accumulator with at least one lithium-ion cell (14a, 14b, 14c, . . . ; 14a′, 14b′, 14c′, . . . ). The system (10) comprises: A central control device (16), a program storage device (18) in operational connection with the central control device (16), at least one data storage device (20) in operational connection with the central control device (16), at least one sensor interface device (22) operationally connected to the central control device (16) for monitoring of such function parameters of at least one lithium-ion cell of the device (14), which works according to galvanic principles, and configured for operationally connecting with at least one external sensor device (26a, 26b, 26c, . . . ) for measuring at least one function parameter of a respective lithium-ion cell, at least one import device (44a, 44b, 44c, . . . ) in operational connection with the central control device (16) and configured for importing of at least one operation parameter of an assigned lithium-ion cell (14a, 14b, 14c, . . . ; 14a′, 14b′, 14c′, . . . ). According to the invention, the central control device (16), the at least one program storage device (18), the at least one data storage device (20), the at least one sensor interface device (22) and the at least one import device (44a, 44b, 44c, . . . ) are integrated into one integrated circuit (12).

The present invention relates to a battery management system for an electrical device, which works according to galvanic principles, in particular a lithium-ion cell or a lithium-ion accumulator.

The term battery management system is understood to be an apparatus for the detection of operational data and for the control of the operation of the device, which works according to galvanic principles, or, respectively, a rechargeable energy storage device. The operational data, for example, comprise the status of the device as e.g. the state of charge, the capacity, the capability and the remaining service life of the device. The control of the device encompasses, for example, the control of the charging process, the control of the discharging process and control for protection against overload or, respectively, incorrect operational states, such as deep discharge or the operation at a high temperature, for example, above a predetermined temperature threshold.

Even though the invention is described in reference to the application in a vehicle and the control of its rechargeable energy storage device for the supply of an electrical drive of the vehicle, it is pointed out that a battery management system with the features of the claims can also be operated and used independent of vehicles or, respectively, may be operated and used for stationary applications.

Battery management systems for rechargeable energy storage devices or, respectively, devices, which work according to galvanic principles, are known from the prior art. For example, German patent application DE 10 2008 009 970, which was filed in the name of the applicant of the present application on the 20 Feb., 2008, describes a battery management system for application in vehicles, which is provided for the central control of one or multiple energy storage devices and which is spatially separated from said devices.

The object of the present invention generally is to expand the potential use of a battery management system.

The solution of said object according to the invention is to maximize the scale of integration of the battery management system such that it can be fabricated in a cheap and compact manner and such that it is consequently capable of being integrated in any device, which works according to galvanic principles or, respectively, in a rechargeable energy storage device in an economical manner and without causing technical or, respectively, geometrical problems. The integration of the battery management system in a certain device, which works according to galvanic principles, allows that the respective device can be operated with a high efficiency and that its lifetime can be extended by an appropriate, and, in particular, sustainable mode of operation.

As claimed, a battery management system is provided for the monitoring and control of at least one device, which works according to galvanic principles, in particular a lithium-ion accumulator with at least one lithium-ion cell. The system comprises a central control device, a program storage device in operational connection with the central control device, at least one data storage device in operational connection with the central control device, at least one sensor interface device operationally connected to the central control device for the measurement of functional parameters of at least one lithium-ion cell of the device, which works according to galvanic principles, and configured for the operational connection with at least one external sensor device for the measurement of at least one functional parameter of a pertinent lithium-ion cell, at least one import device in operational connection with the central control device and adapted for the import of at least one operational parameter of a pertinent lithium-ion cell of the device, which works according to galvanic principles.

According to the invention, the central control device, the program storage device, the at least one data storage device, the at least one sensor interface device and the at least one import device are integrated into one integrated circuit. The integration of said components in one integrated electrical circuit offers the advantage that the essential elements of the battery management system are joined in one component, in particular in a compact manner, and that the battery management system is capable of being technically easily integrated in the device.

Preferably, the battery management system is configured for application in a vehicle. Thereby a broad technical field of application and an economically large market are opened up.

A lithium-ion accumulator is understood to be a device in which energy or, respectively, electrical charge is electrochemically stored in an electrode and the charge is supplied to a complementary electrode in the form of an electrical current via a circuit, which connects both electrodes through an external consumer load for the supply of the external consumer load with electrical energy, and which can be recharged after release of an substantial part of its stored energy by being supplied with an electrical charging current.

A central control device is understood to be a device, in particular a control device, which is capable to monitor or, respectively, control the functions and, respectively, the operation processes of other devices of the battery management system, such as the storing of monitored operational data as a function of time, the addressing or, respectively, selecting (multiplexing) of multiple accumulator cells, which are connected to the battery management system, the reading of operational status data, which are detected by sensors, or the data communication with other control systems. The central storage device can, in particular, be programmable.

A data storage device is understood to be a device, which generally can store data, such as operational data or status data, respectively, as a function of time and can supply the same for readout.

A sensor interface device is understood to be a device, which is appropriate for data communication, at least for the import of measurement data into the operation management system, the measurement data being detected by sensors, which are arranged in the vicinity of a device, which works according to galvanic principles, or, if applicable, supplied externally from the integrated part of the battery management system, preferably for the bi-directional data communication for the import of sensor data and the control of, in particular, also “intelligent” sensors.

An import device is understood to be a device which can affect the operational status for the device that works according to galvanic principles, in particular which can adjust the same to one or multiple desired values. For said purpose, the import device can be controlled by other control devices of the battery management system, such as the central control device or a separately supplied process control device, respectively.

An adjustable device is understood to be a device which is operationally connected with an import device of the battery management system and which thereby can be changed in its operation status or, respectively, adjusted to a desired value, to adjust at least one operational parameter of a device, which works according to galvanic principles. The adjusted device can be external in relation to the battery management system.

Advantageously, the central control device, the at least one program storage device, the at least one data storage device and the at least one sensor interface device are implemented in accordance with semiconductor technology, which is known for common integrated circuits. This offers the advantage that known technologies for the designing and fabricating of said devices can be used, in particular economically and technically efficient ones. In particular, said semiconductor technology can be a 0.13 μm technology, in particular a 0.13 μm BCD-technology. The application of a novel 0.13 μm technology practically allows for the highest integration level of the elements or, respectively, devices of the battery management system in the integrated circuit, in accordance with present technical standards.

BCD-technology (English: Bipolar CMOS DMOS) is a technology, which is known from the prior art for so called “smart power ICs”. BCD-technology essentially is a combination of certain processes, including the respective insulation of the different components and circuit elements on one chip. For the fabrication of smart power ICs, generally, a plurality of different technologies is used which differ in their implementation effort, in the repertoire of the components, in the electrical strength and the possible circuit topologies. The most important distinguishing feature is the technology, by which the different components and circuit parts from one chip are insulated against each other, e.g. self-insulation, insulation by PN-junctions or, respectively, dielectric insulation. In particular, it is envisioned to use a novel 0.13 μm BCD-technology of the 9^{th} generation. Thereby, it is possible to integrate the manifold of required functions of a battery management system onto one single integrated circuit, namely:
1. Circuits with analog signals or mixed analog and digital signals, for example for the operational use with sensor devices as arbitrarily available;
2. Digital high-speed logic and micro processors in a compact 0.13 μm CMOS technology, in particular for the central control device;
3. Data storage devices, as for example flash storage, in particular eNVM, or, respectively, so called data register devices (data logger);
4. High frequency electronics up to 2.4 GHz and 10 GBit/s in the external and internal data communication; and
5. Power electronics up to about 60 V and 4 A (maximum value or, respectively, peak value) for the control of import devices or, respectively, actuating elements.

Therein, a certain scale of integration of a complex battery management system can be achieved in one single integrated electrical circuit or, respectively, on a single chip and thus a technically high scale of integration, which was unrivalled before the development of the present invention.

The system can further provide at least one driver device for operating or, respectively, controlling of the at least one lithium-ion-cell, which is preferably integrated into the integrated circuit. The provision of a driver device within the battery management system increases the scale of integration and allows for an import device to be controlled by the battery management system in all of its functions.

The battery management system can further provide a process control device, which is preferably integrated into the integrated circuit, which can monitor or, respectively, control the operating states of the cells of the devices, which work according to galvanic principles, via the driver devices, in particular for the control of one or multiple driver devices for operating or, respectively, controlling at least one lithium-ion cell, in particular for the control of temporal processes of sequentially executed tasks or, respectively, actions on the operating states of the devices, which are connected to the battery management system and work according to galvanic principles. The provision of a process control device in the battery management system even further increases the scale of integration and the flexibility or, respectively, the possible use of the system.

The integrated circuit can provide an architecture, which is scalable in dependence of a power class, in particular a power class of the device, which works according to galvanic principles. Thereby, the usability of the battery management system for an application within devices, which work according to galvanic principles, is increased to a wide field of possible applications.

The circuit can comprise an architecture, which is scalable in regard to a smallest power class up to a highest power class. In particular, the lowest power class may comprise powers in the range of about 1 W (Watt) to 10 W. The highest power class may comprise powers of not less than 50 kW (Kilowatt). The scalability of the integrated circuit for lowest or, respectively, low up to high or, respectively, large powers even further increases the usability of the battery management system for different types and areas of devices, which work according to galvanic principles.

The at least one driver device can be implemented as a power electronic device. In particular, the at least one driver device can be implemented as 45 V (Volt) to 60 V power electronic device. This allows a cooperation of the battery management system with the devices, which work according to galvanic principles, even for high power classes or, respectively, the control of adjusted devices of very different kinds, such as transformers, ventilation blowers, or coolant circulation pumps for a thermomanagement of the devices, which work according to galvanic principles.

The central control device can be a micro control device or, respectively, a micro controller, in particular a 16/32 Bit controller. The fabrication technology for such a central control device is well-known in the prior art, is economically and technically efficient, optimized and allows further universal programming of the operation of the battery management system and its cooperation with external devices, which even further increases the possible uses of the battery management system.

The circuit can further comprise a system interface device for digital data communication with an external entity, in particular, for example, with an external vehicle control device. Updated software for controlling the central control unit can be transferred via the system interface device, for example, and written into the integrated circuit, in particular into the program storage device. Updated software can render the battery management system usable for further types of devices, which work according to galvanic principles, and, therefore, may render the potential use of the battery management system even more universal or, respectively, more versatile, or can generally adapt the control and operation software of the battery management system for a new kind of accumulators or update the same.

The system interface device can be implemented in 0.13 μm BCD technology, which facilitates the integration into a circuit or, respectively, renders the same easier. The system interface device can be configured for the data communication after at least one of the standards LIN, CAN or Flexray. Thus, the most convenient standards, which are presently used in the car industry can be supported and the battery management system is rendered suitable for a big market.

In particular, if the battery management system is to be configured for small or low power classes, respectively, the process control can be integrated into the circuit and can be implemented in 0.13 μm BCD technology, in particular.

This increases the scale of integration and facilitates the integration of the process control device with the other devices of the battery management systems, in particular with the central control device and the at least one import device even further.

If the battery management system is to be adapted for high or, respectively, higher or highest power classes, the process control device can be provided externally in relation to the circuit and can be particularly implemented with power semiconductors, in particular COOL-MOS or IGBT (English: Insulated Gate Bipolar Transistor) power semiconductors. This allows that the high currents, which in this case are required for the process control, do not have to be considered for the design of the integrated circuit, but nevertheless enable the integration of a process control so configured in a battery management system, which is implemented as a fitting unit component.

Advantageously, if the battery management system has to be adapted for small or low power classes, respectively, at least one driver device can be integrated into the circuit, and can be implemented in 0.13 μm BCD technology, in particular. The integration of the driver device into the circuit increases the scale of integration and the implementation in 0.13 μm BCD technology facilitates the integration with the other devices or components—via wires—, respectively, in the integrated circuit.

If the battery management system has to be adapted for high and highest power classes, at least one driver device can be provided externally in relation to the circuit and can be provided, in particular, with power semiconductors, in particular COOL-MOS or IGBT power semiconductors. As already mentioned before for the process control device in the cases of high power classes, this opens up the possibility that the high currents, which are required in the driver device, do not have to be taken into account for the design of the integrated circuit, but the driver device can nevertheless be integrated into a battery management system, which is implemented as a single fitting component.

Advantageously, the process control and at least one driver device can be provided externally relative to the circuit for adapting the battery management system for high and highest power classes and can be implemented, in particular, as power semiconductors, for example COOL-MOS or IGBT power semiconductors.

The sensor interface device can be configured for data communication with one or with multiple sensor devices for the measurement of functional parameters of a cell of a device, which works according to galvanic principles, wherein one respective sensor device is selected from the following group: Sensor for the measurement of chemical parameters of the device, which works according to galvanic principles, such as, for example, the electrolyte concentration, sensor for the measurement of the temperature of the device, which works according to galvanic principles, sensor for the measurement of the cell voltage, sensor for the measurement of a current, as for example a discharge current, which is put out by a cell of the device, which works according to galvanic principles, or of a charge current, sensor for the measurement of an internal resistance of a cell of a device, which works according to galvanic principles, sensors for the measurement of a frequency dependent impedance of a cell of a device, which works according to galvanic principles, or any combination thereof. The data communication based on such a variety of different sensors allows to comprehensively and completely characterize the actual state of a respective cell of the device, which works according to galvanic principles, and thus allows the operation of the device with the highest possible efficiency, in particular with optimum charge and discharge, as adapted to the actual state of the device, which works according to galvanic principles.

The battery management system can be configured to perform one or multiple tasks, which are selected from the following group: Monitoring of an actual state of a cell of the device, which works according to galvanic principles, as for example the charge status, the capacity, the capability and the remaining service life, control of a charge current, in particular regarding the balancing (that is a cell specific control of the charge current within a plurality of cells, which are connected electrically to an accumulator, for example in series or, respectively, in parallel, with the aim to achieve an uniform charge status of the cells at the charging), control of a discharge current, in particular regarding the balancing, a protection against overload, protection against overcharge, protection against deep discharge, protection against a temperature overload, protection against other non-appropriate operational states, temperature management, a protection circuit in case of mechanical damaging for or, respectively, from respectively at least one cell or all cells of the device, which works according to galvanic principles, as well as further optimization of the energy consumption of the system, which is supplied by the device, which works according to galvanic principles, with electrical energy and energy feed back from the system, which is supplied with electrical energy, to the device, which works according to galvanic principles, or combinations of the before mentioned tasks. The ability to perform said comprehensive and versatile tasks renders the battery management system appropriate to meet the demanding requirements for application in the vehicle industry, in particular, for example, sensor recognition of the accumulator charge status, selective intervention regarding the characteristics of the accumulator for the regulation and optimization of emergency protection actions, system consumption, performance prediction, thermomanagement and battery age recognition.

The data storage device can be configured as flash storage for the fast up-take of large data amounts or as a data register device or, respectively, a data logger. Thereby, the operation and status history of the device, which works according to galvanic principles, can be detected, stored and made available for evaluation, for example for predicting future operation and performance states of the device, which works according to galvanic principles.

The battery management system can be configured for updating the program control, which is stored in the program storage device, such as, for example, for the adaptation to a new accumulator technology or, respectively, to a new software update status. For that purpose, the complete process control of the battery management can be realized as software and can therefore be configured to be capable of being updated. This increases the potential uses of the battery management system or, respectively, its cooperation with versatile, different accumulator types even further.

The system interface device can be configured for receiving software updates of the program control, which is stored in the program storage device, and for forwarding the software updates to the program storage device, in particular, to achieve the before mentioned technical advantages even easier.

The integrated circuits can be hosted in a housing, which is robust in relation to external mechanical influences and thus can also be configured appropriately for different conditions of use, which are required in the vehicle industry, in particular.

The integrated circuit or, respectively, the total battery management system can be configured to be robust against electromagnetic interference fields, which act from the outside, in particular against an EMV (electro motoric voltage) influence, for achieving the same advantage and for allowing that the battery management system is capable of cooperating with versatile different kinds of electronic circuits, without being influenced in its internal operation or being interfered.

Further advantages, features and possible uses of the present invention can be derived from the following description of embodiments, which do not limit the invention, also in the context of the Figures. It is shown:

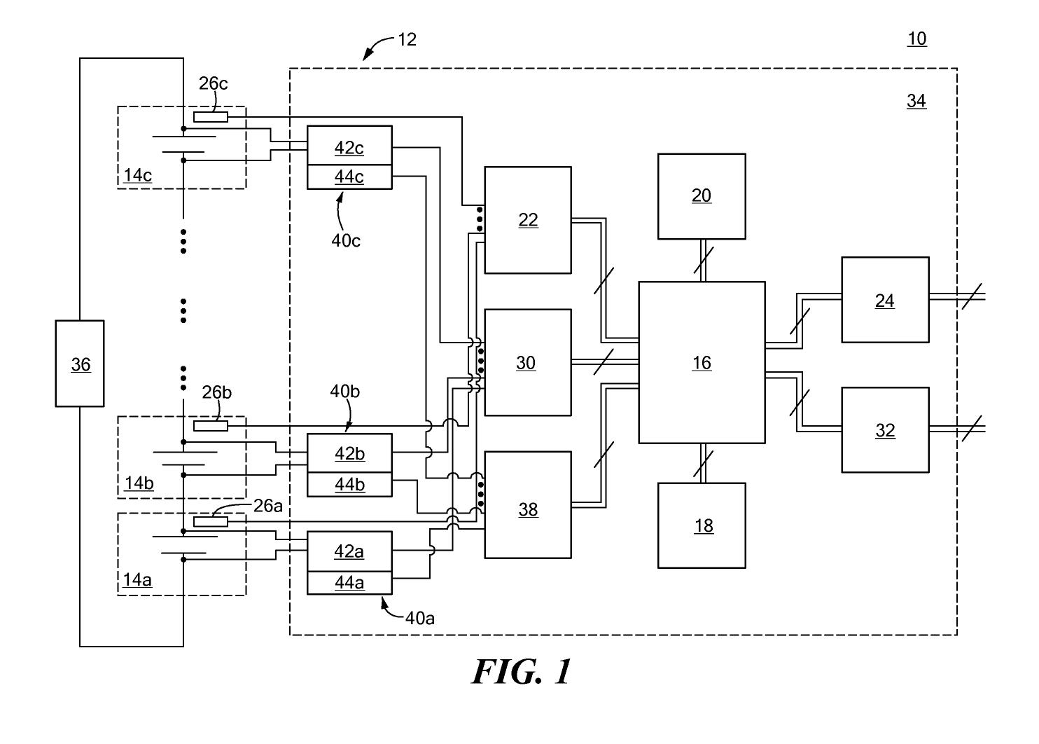

FIG. 1 a schematic circuit diagram of an integrated battery management system in a first embodiment of the invention;

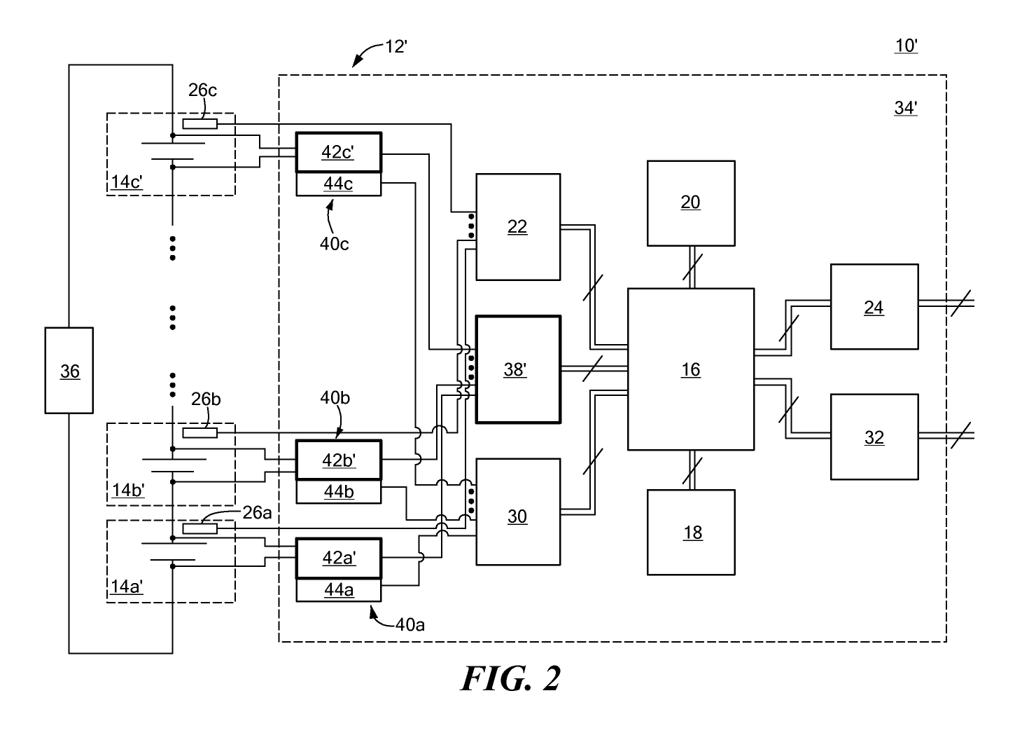

FIG. 2 a schematic circuit diagram of an integrated battery management system in a second embodiment of the present invention.

In the embodiments shown in the FIGS. 1 and 2, the battery management system 10 is for monitoring and controlling a plurality of lithium-ion cells 14a, 14b, 14c, . . . . The lithium-ion cells 14a, 14b, 14c, . . . which are connected with each other, together define one lithium-ion accumulator 14, which is configured for the supply of a system 16 with electrical energy, which is to be supplied with said energy, for example the current consumer loads of a vehicle.

FIG. 1 schematically shows a battery management system 10, which comprises, as a central element, an integrated circuit 12, in which, amongst others, the following devices are integrated: A central control device 16, a program storage device 18 in operational connection with the central control device 16, a data storage device 20 in operational connection with the central control device 16, a sensor interface device 22 for importing or, respectively, monitoring the functional parameters of at least one device 14, which works according to galvanic principles, which is operationally connected to the central control device 16 and which is configured for the operational connection with at least one external sensor device 26a, 26b, 26c, for the measurement of at least one functional parameter, a plurality of control apparatuses 40a, 40b, 40c, which, respectively, are configured for the control of a device, which works according to galvanic principles, which in this embodiment is a lithium-ion accumulator 14 with a serial connection of multiple lithium-ion cells 14a, 14b, 14c, . . . . The lithium-ion cells 14a, 14b, 14c, . . . of the lithium-ion accumulator can also be connected in a parallel circuit or in a mixed circuit of cells, which are serially connected to form partial groups, the partial groups being circuited in parallel, for the adaptation to a predefined voltage or, respectively, current requirement of the system 36, which is to be supplied with electrical energy.

Any respective control apparatus 40a, 40b, 40c, . . . is assigned to a lithium-ion accumulator cell 14a, 14b, 14c, and, respectively, comprises a driver device 42a, 42b, 42c, . . . and an import device 44a, 44b, 44c, . . . , for example in the form of a transistor (not shown), with an analog/digital converter (not shown), which converts an analog current or, respectively, voltage signal, which represents the actual operation status of an assigned cell 14a, 14b, 14c, . . . to a digital signal and forwards the same to a signal import device, such as, for example, a multiplexer 30.

A plurality of sensors 26a, 26b, 26c, . . . are connected in the integrated circuit 12 of the battery management system via the sensor interface device 22 for monitoring the actual status of the lithium-ion accumulator 14 or, respectively, the individual cells 14a, 14b, 14c, . . . of the lithium-ion accumulator 14. At least one sensor 26a, 26b, 26c, . . . is assigned to each lithium-ion accumulator cell 14a, 14b, 14c, . . . . Multiple different sensors for detecting different operational parameters or characteristics of the cell can also be assigned to each accumulator cell.

In order to charge or to discharge the lithium-ion accumulator 14 with the highest possible efficiency, a plurality of different sensors is provided, which can detect the actual status of each cell in relation to the capacity and the charge status in the accumulator system 14, and which are selected depending on the accumulator type, to measure, in particular, the following accumulator characteristics: Chemical parameters, for example the degree of concentration of the electrolyte, temperature of a cell, electrical parameters of a cell, for example the voltage, the current, the internal resistance at a low, or respectively, a high pulse load and/or the frequency dependent impedance of a cell. In FIGS. 1 and 2, one sensor 26a, 26b, 26c, . . . is shown for a lithium-ion cell 14a, 14b, 14c, . . . , respectively, for simplicity. Any given cell 14a, 14b, 14c, . . . can, however, not only be assigned to one, but also to two, three, four or more different sensors for the measurement of different accumulator characteristics and can be assigned in the cell, or respectively mounted at the cell, or respectively connected to the cell, such that said accumulator characteristics can be measured.

The electrical signals, which are detected by the sensors, including the sensors 26a, 26b, 26c, . . . and which are assigned to the accumulator cell parameters, are transferred via the sensor interface device 22 to the central control device 16, in which they are systematically sorted and, in particular, brought in a chronological order per parameter or, respectively, signal, and forwarded via the central control device 16 to the data storage device 20, where they are registered or, respectively, stored, and are provided for later evaluation and can be, for example, read out by the central control device 16. For said purpose, the data storage device 20 comprises a fast controllable, so called flash memory or, respectively, a data register device (data logger). Thereby, a so called life-cycle profile is generated in the data storage device 20, which serves to store the chronological sequences of all parameters, which are detected and which characterize the operational status or, respectively, the status of each accumulator cell and to have them available for evaluation, for determining the optimum control of discharge and charge currents and for the forecast of future operational statuses.

On the basis of the data, which are stored in the data storage device 20, the battery management system 10 has the ability to operate the connected lithium-ion accumulator 14 and, as also provided by the present invention, each single cell 14a, 14b, 14c, of the accumulator 14 with the highest degree of efficiency and to maximize the life time.

In order to influence the operational status, including the control of the charge currents or, respectively, the discharge currents of the cells 14a, 14b, 14c, the battery management system comprises the following elements: a plurality of control apparatuses 40a, 40b, 40c, . . . for operating or, respectively, controlling of each lithium-ion cell 14a, 14b, 14c, . . . and a process control device 38, which is operationally connected to the central control device 16 via a corresponding control line, which is configured for a bi-directional signal transfer, and which is supplied for the control of the operation status of each accumulator cell 14a, 14b, 14c, . . . via the control apparatus 40a, 40b, 40c. Thereby, the control apparatuses 40a, 40b, 40c, . . . are, respectively, assigned to one cell 14a, 14b, 14c, . . . and connected with a corresponding cell via the corresponding pairs of power lines.

A respective control apparatus 40a, 40b, 40c, . . . comprises a driver device 42a, 42b, 42c and an import device 44a, 44b, 44c with an analog/digital converter (not shown) for the operation or, respectively, the control of a respective lithium-ion cell 14a, 14b, 14c, . . . . A respective driver device 42a, 42b, 42c, . . . receives a corresponding control current from the process control device 38, by which the driver device 42a, 42b, 42c, adjusts a corresponding import device (not shown), which is contained therein, which is in particular configured as transistor and which adjusts the set current for a corresponding cell 14a, 14b, 14c, . . . .

Correspondingly, a respective import device 44a, 44b, 44c, . . . can also take up a charge or, respectively, a discharge current of a respective cell 14a, 14b, 14c or, respectively, a signal via a respective driver device 42a, 42b, 42c, . . . , which is representative for a corresponding charge or, respectively, discharge current and feed it to a respective analog/digital converter (not shown), which is contained in the import apparatus. A corresponding analog/digital converter converts the current (depending on the operational status of the cell 14a, 14b, 14c, . . . the discharge or charge current) or, respectively, the representing signal into a corresponding digital signal. The digital signal is fed via a corresponding line to the multiplexer 30, which can choose one of the import devices from the plurality of import devices 44a, 44b, 44c, . . . which are connected to the same, controlled by the central control device 16 and which can feed the signal, which is generated by the import device 44a, 44b, 44c, . . . to the central control device 16. The values or, respectively, signals, which are fed to the central control device 16 in this way and are representative for an operational parameter of the cells 14a, 14b, 14c, are sorted in the data storage device 20 in a chronological sequence and according to signal types, and are stored as part of the life-cycle profile of a corresponding cell 14a, 14b, 14c or, respectively, of the accumulator 14.

In the program storage device 18, subprograms or, respectively, modules are stored, which can be loaded for execution into the central control device 16. Thereby, each parameter, which is desired and capable to be measured by the plurality of sensors of a respective cell 14a, 14b, 14c of the accumulator 14, can be read out, detected and used for the control of the operational status of a respective cell 14a, 14b, 14c, . . . . For said purpose, the process control device 38 controls the temporal sequence and the intensity of the control of the operation status of the respective cell 14a, 14b, 14c, . . . by a respective driver device 42a, 42b, 42c, . . . .

The integrated circuit 12 of the battery management system further comprises a system interface device 24 for the digital data communication with external control systems or control devices. The system interface device 24 is capable to comply with multiple interface and communication standards including the LIN-, CAN- and Flexray standards, which are, in particular, common according to prior art, which are common in the vehicle industry for a universal applicability of the battery management system 10, in particular in different vehicle control types.

Further, the integrated circuit 12 comprises a further interface 32, which is configured as a master-slave interface, in particular, for the operational connection of the battery management system with other battery management systems and for the import of software-updates into the central control device 16 and the program storage device 18.

The interface 32 allows that multiple accumulators, which are connected to a respective battery management system, can be connected in series or in parallel with each other and that the respective battery management systems, which are assigned to the accumulators, can be operationally connected (corresponding to the connection of the accumulators in series or in parallel to each other) such that the plurality of battery management systems of the individual lithium-ion accumulators behave and can be seen (operated or, respectively, controlled) as a single, virtual integral management system with respect to the outside environment, in particular the previously mentioned external control system or control device.

The battery management system 10 is capable to fulfil the following tasks in the context of monitoring and controlling the cells 14a, 14b, 14c, . . . of the accumulator 14, in particular, by means of appropriate programming or, respectively, provision of corresponding subprograms in the program storage device 18:
Monitoring of the present cell status (charge status, capacity, capability, residual life time) of a respective cell 14a, 14b, 14c, . . . ,
optimization control of the charge process of a respective cell 14a, 14b, 14c, . . . under consideration of the balancing,
optimization control of the discharge process of a respective cell 14a, 14b, 14c, . . . under consideration of the balancing,
protection circuiting against overload and incorrect operation status of a respective cell 14a, 14b, 14c, . . . ,
temperature management of a respective cell 14a, 14b, 14c, . . . ,
controlled protection circuit in the case of electrical or mechanical damaging of the accumulator system 14 from outside,
storage of the life-cycle profile of the accumulator 14 including the life-cycle profile of a respective cell 14a, 14b, 14c, . . . into the data register device (data storage device) 20,
optimization of the consumption of the system 36, which is supplied by the lithium-ion accumulator 14, by a performance forecast of the accumulator 14,
digital data communication of the battery management system 10 with external control systems or control devices.

The task or, respectively, challenge, which underlies the present invention, is to integrate the different electronic function blocks into a single integrated circuit or, respectively, onto a single chip, which as a group work at different electrical voltage-, current- and power classes or, respectively, regimes. The groups, which differ in regard to their electronic circuiting or, respectively, in regard to their voltage-, current- and power regimes, comprise the following circuit types:
1. Circuits with mixed analog and digital signals for the control and read-out of the different sensors, such as, in particular, used in the sensor interface device 22 or, respectively, in the sensor devices,
2. digital high-speed logic, as used, for example, in the central storage device 16, the system interface device 24, the interface 32 and the multiplexer 30, which are configured in highly integrated compact semiconductor technology, in particular formed as 0.13 μm CMOS technology on the chip,
3. fast flash-memory (eNVM) data logger, as used, for example, in the data storage 20,
4. high frequency electronics up to 2.4 GHz and 10 GBit/s for external and internal digital data communication, as used, for example, in the system interface device 24, the sensor interface device 22 or, respectively, the interface 32,
5. power electronics up to 60 V and 4 A (top- or respectively peak value), as used, for example, in the process control 38 or respectively the driver device 42a, 42b, 42c, . . . .

In the both embodiments, shown in the FIGS. 1 and 2, at least the central control device 16, the program storage device 18, the data storage device 20, the sensor interface device 22, the system interface device 24, the interface 32, the multiplexer 30 and the voltage controller 28 are joined together in a highly integrated area of the integrated circuit 12 or, respectively, 12′, and also in a housing 34 or, respectively, 34′. Thereby, a system-on-chip scale of integration is achieved that is without parallel so far.

The embodiments, shown in FIGS. 1 and 2, are similarly equipped and are functionally comparable as far as the equipment with elements or, respectively, functional electronic circuits is concerned. They merely differ in their system architecture. The system architecture is adapted to the power class of the lithium-ion accumulator 14, which is to be used with the battery management system 10. The architecture of the battery management system according to the invention is scalable from a power area, which is referred to herein as low power class (1 W (Watt) up to 10 W), to a power area of more than 50 kW (Kilowatt), herein referred to as highest power class.

For small power classes and, in particular, said smallest power class, all components, also including the power semiconductor, are completely integrated into the circuit 12. This means that the central storage device 16, the program storage device 18, a voltage control device 28, the system interface device 24, the interface 32, the sensor interface is device 22, the multiplexer 30, the process control 38, the control apparatus 40a, 40b, 40c including the driver devices 42a, 42b, 42c, . . . contained therein and the import devices 44a, 44b, 44c with respective analog/digital converter (not shown) are all completely integrated into one integrated circuit 12, as shown in FIG. 1. The embodiment of FIG. 1 of the battery management system is therefore, in particular, appropriate for small power class including the smallest.

FIG. 2 shows a battery management system 10′ of a second embodiment of the present invention. The battery management system 10′ in FIG. 2 is configured for higher power classes, including the highest power class (>50 kW). In said second embodiment, the electronic circuits, which are shown in FIG. 2 with bold frames, which are in particular the process control device 38′, the driver devices 42a′, 42b′, 42c′, are adapted to the high power class and are arranged with corresponding larger power semiconductors, which are arranged externally with reference to the circuit 12′, and which are, in particular, configured as COOL-MOS or IGBT power semiconductors, which are not arranged within the housing 34′ of the integrated circuit 12′, in which the other elements are arranged. The other elements are preferably arranged in the integrated circuit 12′: The control device 16, the program storage device 18, the data storage device 20, the sensor interface device 22, the system interface device 24, the interface 32, the multiplexer 30, the voltage controller 28, the import devices 44a′, 44b′, 44c′ with the respective analog/digital converters (not shown).

In both embodiments of the FIGS. 1 and 2, the complete process control for the battery or, respectively, accumulator management, which is stored in the program storage device 18, is realized in software and can be read from the outside for the respective application or, respectively, the respective accumulator type as an update via the interfaces 32 or 24 and can be transferred into the central storage devices 16 and the program storage device 18. Thereby, the battery management system 10, 10′ cannot only be adapted to an improved software status but also to new, versatile, for example, also future, battery or, respectively, accumulator technologies.

### REFERENCE LIST

10, 10′ battery management system (for small or, respectively, high power class)
12, 12′ integrated circuit (for small or, respectively, high power class)
14, 14′ lithium-ion cell (for small or, respectively, high power class)
14a, 14b, 14c, . . . lithium-ion cell (small power class)
14a′, 14b′, 14c′, . . . lithium-ion accumulator (high power class)
16 central control device
18 program storage device
20 data storage device (integrated)
22 sensor interface device (integrated)
24 system interface device
26a, 26b, 26c, . . . sensor device
28 voltage controller (V+)
30 multiplexer
32 master-slave interface
34, 34′ housing (for small or, respectively, high power class)
36, 36′ supplied system (for small or, respectively, high power class)
38 process control device (internally arranged)
38′ process control device (externally arranged)
40a, 40b, 40c, . . . control apparatus (small power class)
40a′, 40b′, 40c′, . . . control apparatus (high power class)
42a, 42b, 42c, . . . driver device (internally arranged)
42a′, 42b′, 42c′, . . . driver device (externally arranged)
44a, 44b, 44c import device (small power class)

1. Battery management system for monitoring and controlling at least one device, which works according to galvanic principles, in particular a lithium-ion accumulator with at least one lithium-ion cell, the system comprising:
a central control device,
a program storage device in operational connection with the central control device,
at least one data storage device in operational connection with the central control device,
at least one sensor interface device operationally connected to the central control device for monitoring of functional parameters of at least one of the lithium-ion cells of the device, which works according to galvanic principles, and configured for operational connection with at least one external sensor device and for measuring of at least one functional parameter of a respective lithium-ion cell,
at least one import device in operational connection with the central control device and configured for importing of at least one operational parameter of an assigned lithium-ion cell of the device which works according to galvanic principles, characterized in that the central control device, the at least one program storage device, the at least one data storage device, the at least one sensor interface device and the at least one import device are integrated in one integrated circuit.

2. Battery management system according to claim 1, characterized in that the central control device, the at least one program storage device, the at least one data storage device and the at least one sensor interface device are realized by means of semiconductor technology, which is known from commonly realized integrated circuits.

3. Battery management system according to claim 2, characterized in that the semiconductor technology is a 0.13 μm BCD-technology.

4. Battery management system according to claim 1, characterized in that the system provides at least one driver device for operating or respectively controlling of the at least one lithium-ion cell.

5. Battery management system according to claim 1, characterized in that the system further comprises a process control device, in particular for controlling of one or multiple driver devices for operating or respectively controlling of the at least one lithium-ion cell.

6. Battery management system according to claim 1, characterized in that the integrated circuit comprises an architecture, which is scalable depending on a power class, in particular a power class of the device, which works according to galvanic principles.

7. Battery management system according to claim 6, characterized in that the circuit comprises an architecture, which is scalable for a smallest power class up to a highest power class.

8. Battery management system according to claim 7, characterized in that the smallest power class comprises powers in the range from 1 W to 10 W.

9. Battery management system according to claim 7, characterized in that the highest power class comprises powers of not less than 50 kW.

10. Battery management system according to claim 4, characterized in that the at least one driver device is realized as a power electronic device, in particular as a 45 V-60 V electronic device.

11. Battery management system according to claim 1, characterized in that the central control device is a microcontroller device, in particular a 16/32 Bit controller.

12. Battery management system according to claim 1, characterized in that the system further comprises a system interface device, which is integrated into the integrated circuit for the digital data communication with the external environment, for example with an external vehicle control device.

13. Battery management system according to claim 12, characterized in that the system interface device is realized in 0.13 μm BCD-technology.

14. Battery management system according to claim 12, characterized in that the system interface device is configured for data communication according to at least one of the standards LIN, CAN or flexray.

15. Battery management system according to claim 5, characterized in that the process control device is integrated into the circuit.

16. Battery management system according to claim 5, characterized in that the process control device is realized in 0.13 μm BCD-technology.

17. Battery management system according to claim 5, characterized in that the process control device is provided externally in relation to the circuit.

18. Battery management system according to claim 5, characterized in that the process control device (38) is configured with power semiconductors, in particular COOL-MOS or IGBT power semiconductors.

19. Battery management system according to claim 4, characterized in that the at least one driver device is integrated into the circuit.

20. Battery management system according to claim 4, characterized in that the at least one driver device is realized in 0.13 μm BCD-technology.

21. Battery management system according to claim 4, characterized in that the at least one driver device is provided externally in relation to the circuit.

22. Battery management system according to claim 4, characterized in that the at least one driver device is configured with power semiconductors, in particular COOL-MOS or IGBT power semiconductors.

23. Battery management system according to claim 5, characterized in that the process control device and at least one driver device are provided externally in relation to the circuit.

24. Battery management system according to claim 5, characterized in that the process control device and at least one driver device are realized as power semiconductor, in particular COOL-MOS or IGBT power semiconductors.

25. Battery management system according to claim 1, characterized in that the sensor interface device is configured for the data communication with one or multiple sensor devices for measuring of functional parameters of a lithium-ion cell, wherein a respective sensor device is chosen from the following group: Sensor for measuring of chemical parameters of a cell of the device which works according to galvanic principles, for example the degree of the electrolyte concentration, sensor for measuring of the temperature in a cell of the device, which works according to galvanic principles, sensor for measuring of a cell voltage, sensors for measuring a current, for example the discharge current or charge current, which are respectively provided or taken up by a cell of the device, which works according to galvanic principles, sensor for measuring of an internal resistance of a cell of the device, which works according to galvanic principles, sensors for measuring a frequency dependent impedance of a cell of the device which works according to galvanic principles, or any combination thereof.

26. Battery management system according to claim 1, characterized in that the system is configured for the purpose to fulfil one or multiple tasks, which are chosen from the following group comprising: Monitoring of an actual status of a cell of the device, which works according to galvanic principles, as for example the charge status, as well as the capacity, the capability, the residual life-cycle, the control of a charge current, a control of a discharge current, protection against overload, protection against overcharge, protection against total discharge, protection against temperature overload, a protection circuit regarding mechanical damaging for/from respective at least one cell or all cells of the device, which works according to galvanic principles, as well as further an optimization of the energy consumption of the system, which is supplied with electrical energy from the device, which works according to galvanic principles, and an energy back-feed from the system, which is supplied with electrical energy by the device, which works according to galvanic principles, back into the device, which works according to galvanic principles, or a combination of the foresaid tasks.

27. Battery management system according to claim 1, characterized in that the data storage device is configured as flash-memory or as a data register device or respectively a data logger.

28. Battery management system according to claim 1, characterized in that the data storage device is configured for the storage of a life-cycle profile of at least one cell of the device which works according to galvanic principles.

29. Battery management system according to claim 1, characterized that in system is configured for updating the program control, which is deposited in the program storage device, as for example for adapting to a new accumulator technology or, respectively, to a new software update status.

30. Battery management system according to claim 12, characterized in that the system interface device is configured for receiving software updates of the program control, which is deposited in the program storage device and for feeding the software update into the program storage device.

31. Battery management system according to claim 1, characterized in that the integrated circuit is taken up in a housing, which is robust against external mechanical influences.

32. Battery management system according to claim 1, characterized in that the integrated circuit or respectively the overall system is configured to be robust against electromagnetic interference fields, acting from outside, in particular against an EMV influence.

33. Battery management system according to claim 3, characterized in that:
the system provides at least one driver device for operating or respectively controlling of the at least one lithium-ion cell;
the system further comprises a process control device for controlling of one or multiple driver devices for operating or respectively controlling of the at least one lithium-ion cell;
the integrated circuit comprises an architecture, which is scalable depending on a power class, in particular a power class of the device, which works according to galvanic principles;
the circuit comprises an architecture, which is scalable for a smallest power class up to a highest power class;
the smallest power class comprises powers in the range from 1 W to 10 W;
the highest power class comprises powers of not less than 50 kW;
the central control device is a microcontroller device, in particular a 16/32 Bit controller;
the system further comprises a system interface device, which is integrated into the integrated circuit for the digital data communication with the external environment, for example with an external vehicle control device;
the system interface device is realized in 0.13 μm BCD-technology;
the system interface device is configured for data communication according to at least one of the standards LIN, CAN or flexray;
the sensor interface device is configured for the data communication with one or multiple sensor devices for measuring of functional parameters of a lithium-ion cell, wherein a respective sensor device is chosen from the following group: Sensor for measuring of chemical parameters of a cell of the device, which works according to galvanic principles, for example the degree of the electrolyte concentration, sensor for measuring of the temperature in a cell of the device, which works according to galvanic principles, sensor for measuring of a cell voltage, sensors for measuring a current, for example the discharge current or charge current, which are respectively provided or taken up by a cell of the device, which works according to galvanic principles, sensor for measuring of an internal resistance of a cell of the device, which works according to galvanic principles, sensors for measuring a frequency dependent impedance of a cell of the device which works according to galvanic principles, or any combination thereof;
the system is configured for the purpose to fulfil one or multiple tasks, which are chosen from the following group comprising: Monitoring of an actual status of a cell of the device, which works according to galvanic principles, as for example the charge status, as well as the capacity, the capability, the residual life-cycle, the control of a charge current, a control of a discharge current, protection against overload, protection against overcharge, protection against total discharge, protection against temperature overload, a protection circuit regarding mechanical damaging for/from respective at least one cell or all cells of the device, which works according to galvanic principles, as well as further an optimization of the energy consumption of the system, which is supplied with electrical energy from the device, which works according to galvanic principles, and an energy back-feed from the system, which is supplied with electrical energy by the device, which works according to galvanic principles, back into the device, which works according to galvanic principles, or a combination of the foresaid tasks;
the data storage device is configured as flash-memory or as a data register device or respectively a data logger;
the data storage device is configured for the storage of a life-cycle profile of at least one cell of the device which works according to galvanic principles;
the system is configured for updating the program control, which is deposited in the program storage device, as for example for adapting to a new accumulator technology or, respectively, to a new software update status;
the system interface device is configured for receiving software updates of the program control, which is deposited in the program storage device and for feeding the software update into the program storage device;
the integrated circuit is taken up in a housing, which is robust against external mechanical influences; and
the integrated circuit or respectively the overall system is configured to be robust against electromagnetic interference fields, acting from outside, in particular against an EMV influence.

34. Battery management system according to claim 33, characterized in that:
the process control device is integrated into the circuit;
the process control device is realized in 0.13 μm BCD-technology;
the at least one driver device is integrated into the circuit; and
the at least one driver device is realized in 0.13 μm BCD-technology.

35. Battery management system according to claim 33, characterized in that:
the at least one driver device is realized as a power electronic device, in particular as a 45 V-60 V electronic device;
the process control device and at least one driver device are provided externally in relation to the circuit; and
the process control device and at least one driver device are realized as power semiconductor, in particular COOL-MOS or IGBT power semiconductors.
